(19) United States
(12) Patent Application Publication
(10) Pub. No.: US 2003/0213809 A1
(43) Pub. Date: Nov. 20, 2003

(54) Message delivery apparatus and system for paper dispensers and similar devices

(76) Inventor: Norman Weigen, Coral Springs, FL (US)

Correspondence Address: David P. Lhota, Stearns Weaver Miller, Suite 1900, 200 East Broward Boulevard, Fort Lauderdale, FL, 33301, US

(21) Appl. No.: 10/463,176

(22) Filed: Jun. 17, 2003

Related U.S. Application Data
(63) Continuation-in-part of application No. 09/724,174, filed on Nov. 28, 2000, now Pat. No. 6,578,728.
(60) Provisional application No. 60/181,644, filed on Feb. 10, 2000.

(51) Int. Cl. G07F 11/00

(52) U.S. Cl. 221/2

(57) ABSTRACT

A message delivery system for paper dispensers having a housing for dispensing paper, audible message delivery annunciator, switch mechanism, timer and speaker, wherein the annunciator stores and delivers at least one message when the switch is closed, the speaker provides an audible output of the message, the switch triggers when paper is dispensed and the timer controls the length of the message and supply of power.

### CROSS REFERENCE TO RELATED APPLICATIONS

This application is a continuation-in-part of application Ser. No. 09/724,174 filed Nov. 28, 2000.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

This invention relates generally to delivery of a message in association with activation of a sensor. More particularly, the invention relates to delivery of voice and possibly printed messages to a recipient upon usage of a common appliance. Still more particularly, the instant invention delivers an audio and possibly printed message to a recipient upon usage of a paper towel dispenser.

2. Description of the Background Art

Successful advertising campaigns require effective communication of the intended message to a targeted audience. A marketing campaign must have a consumer's attention to have a chance of success. Some devices known place advertisements at points of purchase or in other public places, but can not guarantee to get a person's attention. It is believed that audible advertisements and/or messages can be very effective if deployed in a manner or place that virtually assures consumer contact and attention, such as public restrooms and newspaper vending machines. In fact, voice messages can be enhanced by simultaneous print messages. While printed advertisements can be found anywhere, including restrooms, they are not necessarily read. One approach to more effectively reach recipients is to trigger voice messages by the use of common appliances and devices. A device and/or system that incorporate voice technology into appliances that people are sure to use would be well received.

The references found disclose several methods and/or devices that attempt to deliver messages to recipients via an audio announcer. However, none of the known devices address and resolve the foregoing as contemplated by the instant invention. For example, U.S. Pat. No. 4,291,342 discloses a talking mailbox structure and a method to play a changeable pre-recorded message when the user opens the mailbox. U.S. Pat. No. 3,825,947 discloses a device for providing a commercial announcement at a point of sale in a retail outlet or other public or semi public location. U.S. Pat. No. 4,984,098 discloses a device that provides audio advertisements at a point of purchase. U.S. Pat. No. 5,690,495 discloses a toilet training device for children that audibly announces an incentive to a child when the child pulls toilet paper from the dispenser. U.S. Pat. No. 5,810,201 discloses a device that dispenses chemicals or personal care chemicals and provides a message prompted by a push button or motion sensor. A remote sensor can detect use of a urinal, toilet or bathroom sink. U.S. Pat. No. 5,532,680 discloses an automatic message playback system that is triggered based upon a motion sensor. Upon sensing a person, a pre-recorded audio message is delivered to the individual passing by the sensor. U.K. published patent document 2,224,922A discloses a waste receptacle that delivers an audio message to the user when a micro switch closes based upon movement of the hinged flap closure of the waste receptacle.

Although several references were found for audio announcers triggered by various sensors, none of the references found disclose an audio announcer in combination and triggered by the use of a paper dispenser, such as a paper towel dispenser or newspaper vending machine, as contemplated by the instant invention. The prior art is limited to motion sensors that trigger either a message or faucet-like device. Such devices can be triggered by a person passing by without ever receiving the person's attention. Therefore, there exists a need for an audio announcer that can trigger and deliver voice messages, and possibly with a printed message, upon usage of a paper dispenser.

### BRIEF SUMMARY OF THE INVENTION

In accordance with the foregoing, it is a primary object of the instant invention to provide a message delivery device and system that improves marketing and public relations effectiveness by delivering targeted audio messages to recipients when they use paper dispensers or similar dispensers.

It is another object of the instant invention to provide a message delivery device and system that delivers at least one audio message when a recipient dispenses paper from a paper dispenser.

It is still another object of the instant invention to provide a message delivery device and system that can store and play a plurality of audio messages.

It is a further object of the instant invention to provide a message delivery device and system that can alter or replace audio messages via radio frequency or hard-wired interface.

It is a still further object of the instant invention to provide a message delivery device and system that reinforces audio messages with an imprint on the paper as it is dispensed and a means to modify the imprinted message.

It is an object of the preferred embodiment of the instant invention to play audio messages upon using a paper towel dispenser.

It is an object of an alternate embodiment of the invention to deliver audio messages upon usage of a newspaper vending machine.

In light of these and other objects, the instant invention comprises a housing, a lever, an annunciator circuit with memory, a speaker and an audio message that work together to deliver audio messages to recipients upon activating the lever. The invention may also include a roller having raised letters for embossing or imprinting paper towel with messages. The external housing comprises a cover, a lever and an opening through which paper towels are dispensed from the apparatus. The cover can be opened via a hinge to reveal a roll of paper towels held in place between two end caps, one of which is attached to the lever, and an audio annunciator that delivers at least one audio message when the lever is pulled. The annunciator circuit includes a programmable chip for holding audio messages and sensors which trigger the playing of messages when paper is dispensed.

The audio annunciator comprises a sensor switch, timer, battery, microprocessor, memory, and a speaker. The sensor/switch preferably comprises magnetic contacts that come together to connect the circuit to power when the lever is depressed. The switch closes an electrical circuit that also activates a timer. The timer provides power to a microprocessor for a length of time necessary to play back one recorded message. When the microprocessor receives power, it retrieves a message digitally recorded in memory, converts it from a digital to analog signal, and passes it to a speaker so that the message may be audibly received by the person who pressed the lever.

In an alternate emodiment, the invention may imprint or emboss paper towels with messages when paper is dispensed. Upon depression of the lever by the user of the paper towel dispenser, a row of teeth on the end cap contacts a gear assembly that drives a pair of rollers. This causes the rollers to rotate and pull a segment of paper from the roll out through the opening in the dispenser. One of the rollers may have raised lettering or other indicia so that when the paper is dispensed, it is imprinted with a message that may complement the audio message. Once the paper is dispensed and the lever is released, a spring pulls the lever to its original resting position.

Another embodiment of the instant invention is adapted for a flat-sheet paper towel dispenser wherein the audio annunciator is triggered by a mechanical switch that senses when a paper towel is removed or being removed. Another embodiment of the instant invention is adapted for a newspaper vending machine whereby the audio annunciator is played when a switch is triggered by the opening of the door.

In accordance with these and other objects which will become apparent hereinafter, the instant invention will now be described with particular reference to the accompanying drawings.

### BRIEF DESCRIPTION OF THE SEVERAL VIEWS OF THE DRAWINGS

FIG. 1 is a front perspective view of instant invention with its cover closed.

FIG. 2 is a front perspective view of the instant invention with its cover open illustrating the relationship between the paper towel and message delivery device. FIG. 3 is a front perspective view of the instant invention with its cover open and paper towel assembly removed to illustrate the message delivery device and system.

FIG. 4 is a front elevational view of the instant invention with the cover opened showing the lever, roller, paper towel, and electrical assemblies.

FIG. 5 is a cut away side elevational side view of the instant invention showing the lever at a first resting position and the orientation of the switch contacts.

FIG. 6 is a cut away side elevational view of the instant invention showing the lever at a second depressed position and the switch contacts closed.

FIG. 7 is a circuit block diagram depicting the components of the audio annunciator circuit. FIG. 8 is a front perspective view of an alternate embodiment of the instant invention adapted for a flat sheet paper towel dispenser.

FIG. 9 is a front perspective view of an alternative embodiment of the instant invention adapted for a newspaper vending machine.

FIG. 10a is a partial cut-away view of the instant invention illustrating the various switch devices that may be employed with paper dispensers.

FIG. 10b is a partial cut-away view of another embodiment of the instant invention employed in a paper dispenser having a serrated bar modified into a mechanical switch trigger that actuates a switch, such as a micro switch or other type of electrical switch.

FIG. 11 is a partial cut-away view of another embodiment of the instant invention illustrating a paper roll switch system adapted for enabling the instant invention.

### DETAILED DESCRIPTION OF THE INVENTION

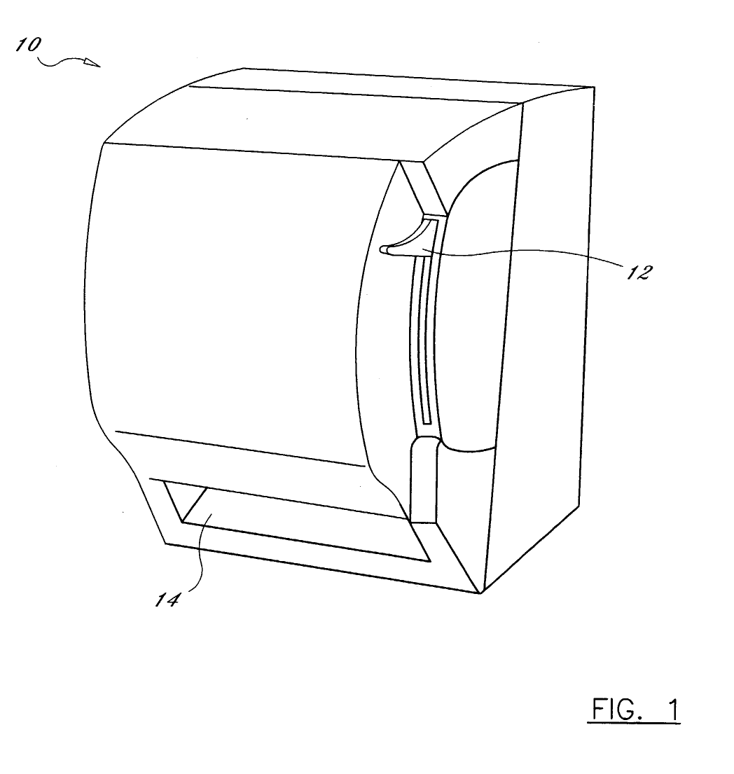

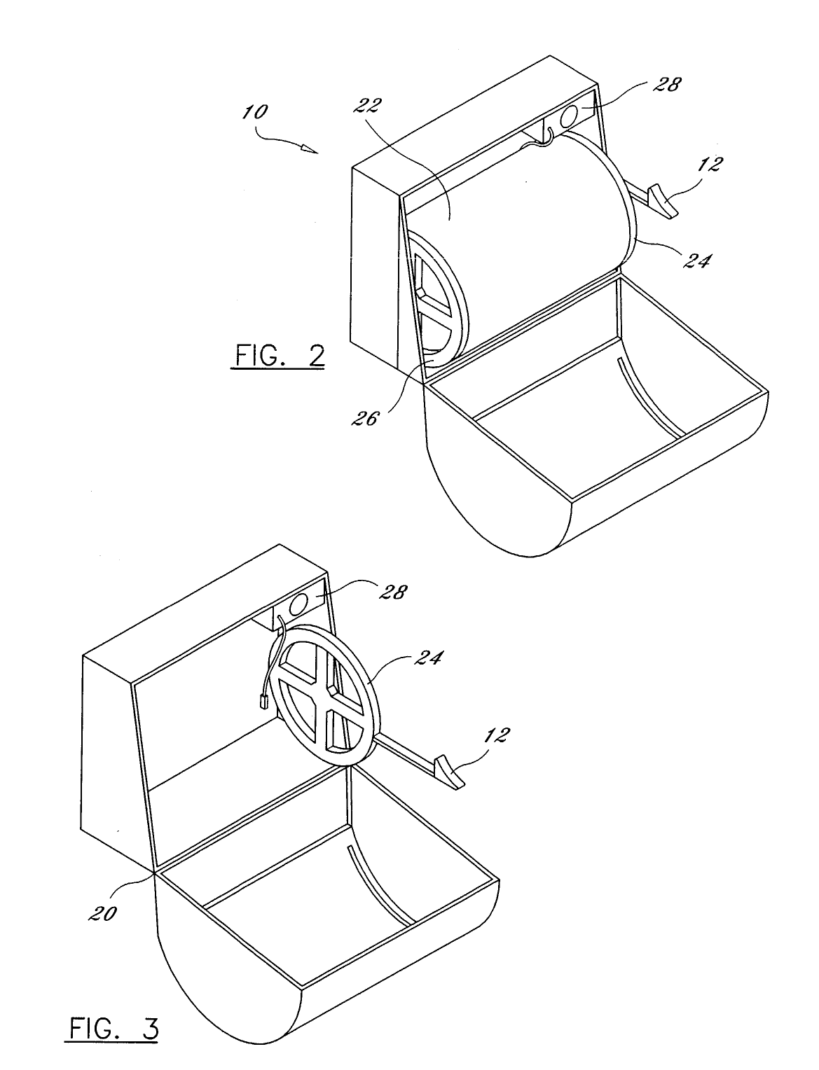

With reference to the drawings, FIGS. 1-11 depict the preferred and alternate embodiments of the instant invention, which is referenced as a message delivery device and/or system and by numeric character 10. Referring to FIG. 1, the invention 10 comprises an external housing with a cover 3, a lever 12, and an opening 14 through which paper is dispensed from the housing 11. Referring to FIGS. 2-5, the cover 3 is pivotally secured tot he housing 11 by a hinge 20 for opening to gain access to a roll of paper towels 22 held in place between two end caps 24 and 26. The end cap 24 is attached to the lever 12. The lever 12 activates between a first position and a second position when pulled and returns to the first position when released by virtue of a spring 68 that is fixed to the housing at one end and secured to the lever chassis at the other end. When the lever 12 is pulled, paper 66 is fed through rollers 62 and 64 and switch contacts 72 and 70 are brought together. The audio annunciator 28 is secured inside the housing 11 and is electrically coupled to the switch contacts 72, 70. The rollers 62 and 64 may be adapted to place a message on the paper when the lever is pulled. The switch contacts 72, 70 come together and electrically close the annunciator circuit when the lever is pulled carrying at least one message to play.

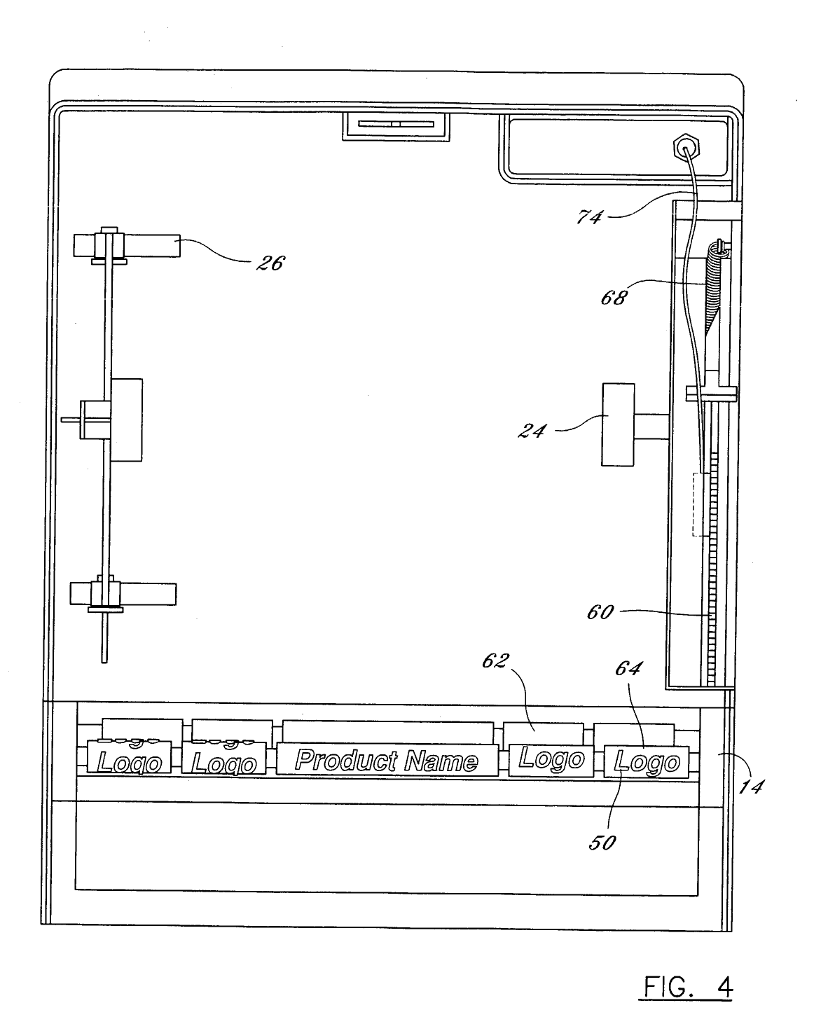

Referring to FIGS. 4-6, upon depression of the lever 12 by the user, a row of gear teeth 60 contact a gear assembly 60 that drives a pair of rollers 62 and 64. This causes the rollers to rotate and pull a segment of paper 66 from the roll 22 out through the opening in the dispenser 14. One of the rollers 64 may have raised lettering or other indicia 50 so that when the paper is dispensed 66, it is imprinted or embossed with a message that may complement the audio message emanating from the audio annunciator 28. Once the paper is dispensed and the lever 12 is released, a spring 68 pulls the lever to its original resting position, i.e. first position.

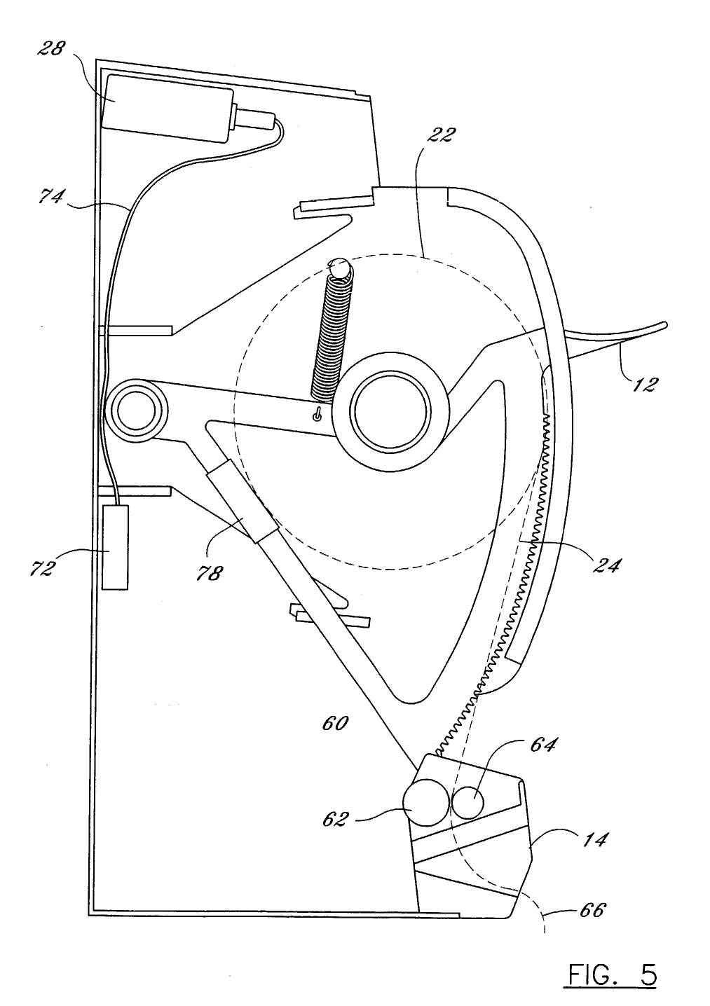

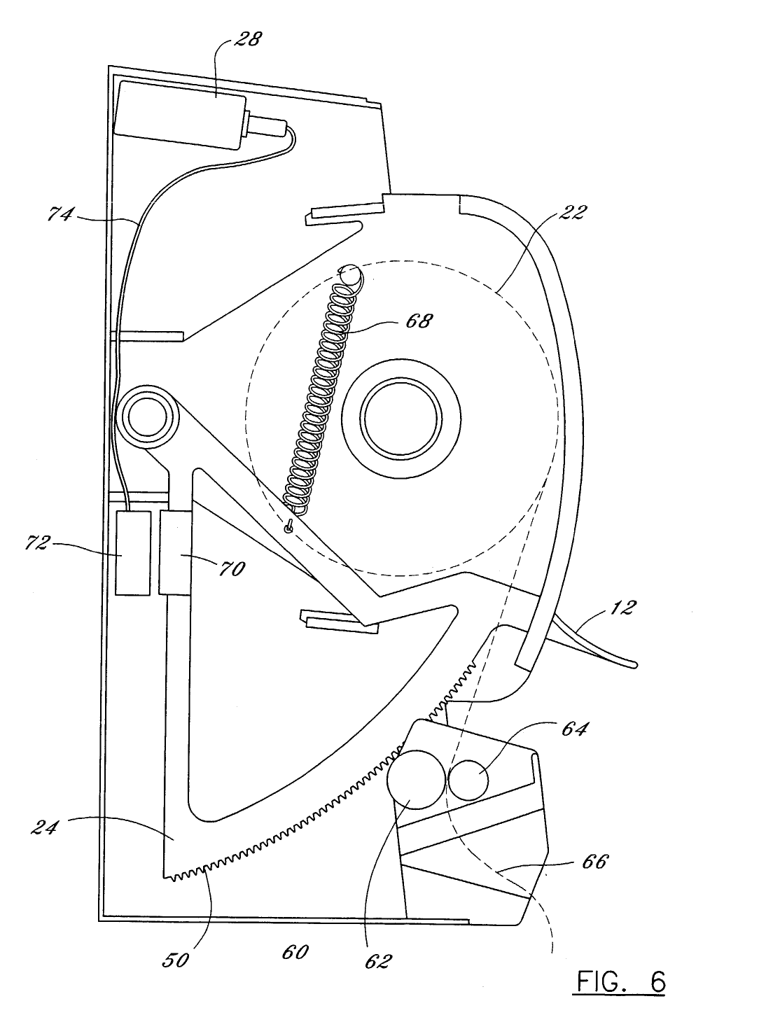

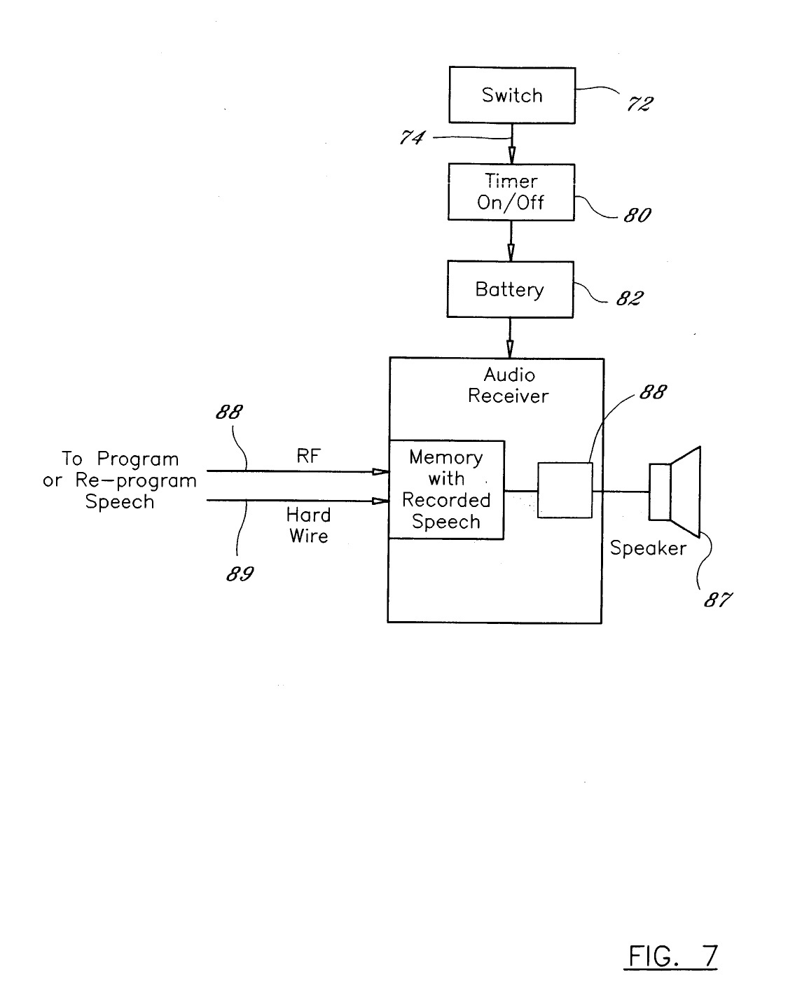

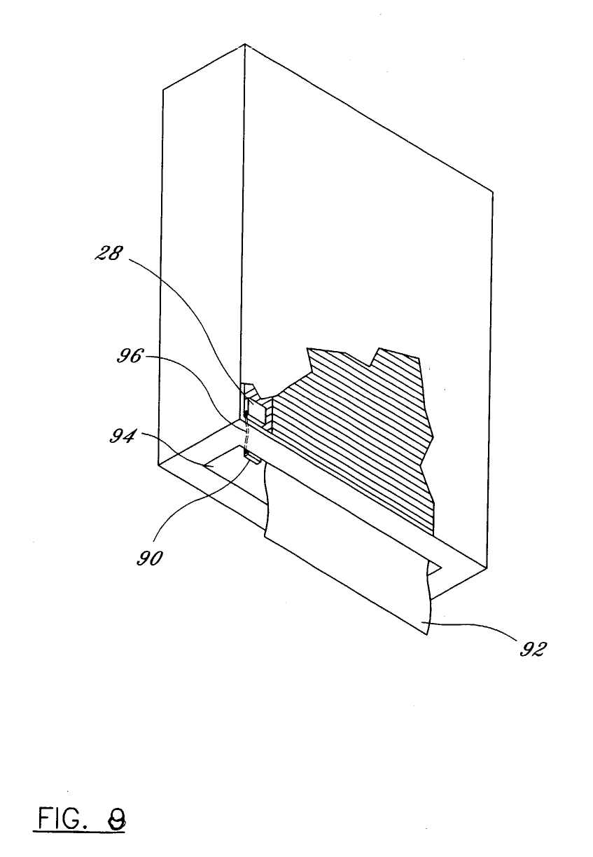

Referring to FIGS. 5-7, a first switch contact 70 is attached to the lever chasiss on arm 12a so that when the lever 12 is activated, the switch contact 70 moves within close proximity to the second magnetic switch contact 72. The switch contacts 70,72 comprise magnetic contacts that create a switch and close the annunciator circuit 29 to apply power, such as battery power 82, to the annunciator 28. Other switches may be employed with the instant invention 10, such as limit switches, toggle switches and push button switches. The alternate switches must be secured in the housing 11 and to the lever chassis arm 12a in functional alignment. With reference to FIG. 7, the annunciator circuit 29 comprises the switch contacts 70, 72, timer (on/off) 80, battery 82 and a microprocessor based audio receiver 84 comprising memory 85 with recorded speech, D/A converter 86, RF input 88, hand wire input 89 and speaker outlet. The annunciator 28 and annunciator circuit 29 may be packaged in a voice chip and may be triggered by a micro switch. The speaker 87 is electrically connected to the annunciator 28 and projects the recorded message. The switch 70, 72 closes the anunciator circuit 28 via a wire connection 74 to the audio annunciator unit 28 and, simultaneously, activates the timer 80. The timer 80 provides power via the battery 82 to the microprocessor 84 for a predetermined length of time necessary to play back at least one recorded message. The timer 80 reopens the circuit to remove power after the predetermined period of time and shuts itself off until it is triggered again via the lever 12 and switch 72.

When the microprocessor 84 receives power, it selects either randomly or sequentially one of the messages digitally recorded in memory 85. The microprocessor 84 then retrieves the digitally recorded message from memory 85, converts it to an analog signal via the digital-to-analog converter 88, and passes it to the speaker 87 so that the message may be audibly received by the person who pressed the lever. The set of messages digitally recorded in memory 85 may be altered or replaced via a radio frequency transmitter device or system 88 or hard-wired 89 interface. The messages may be played randomly or in sequential order.

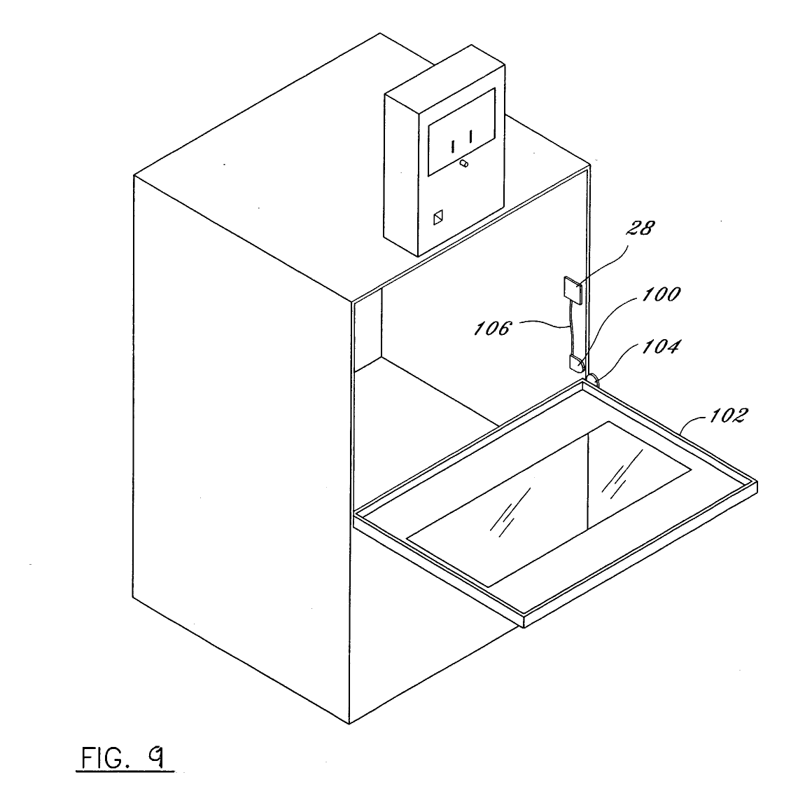

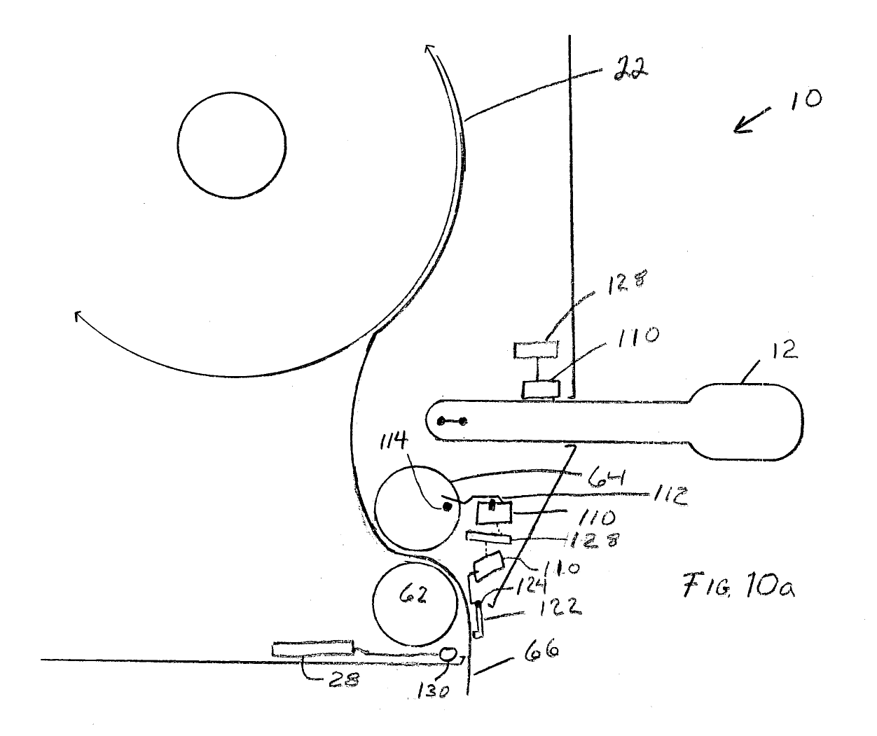

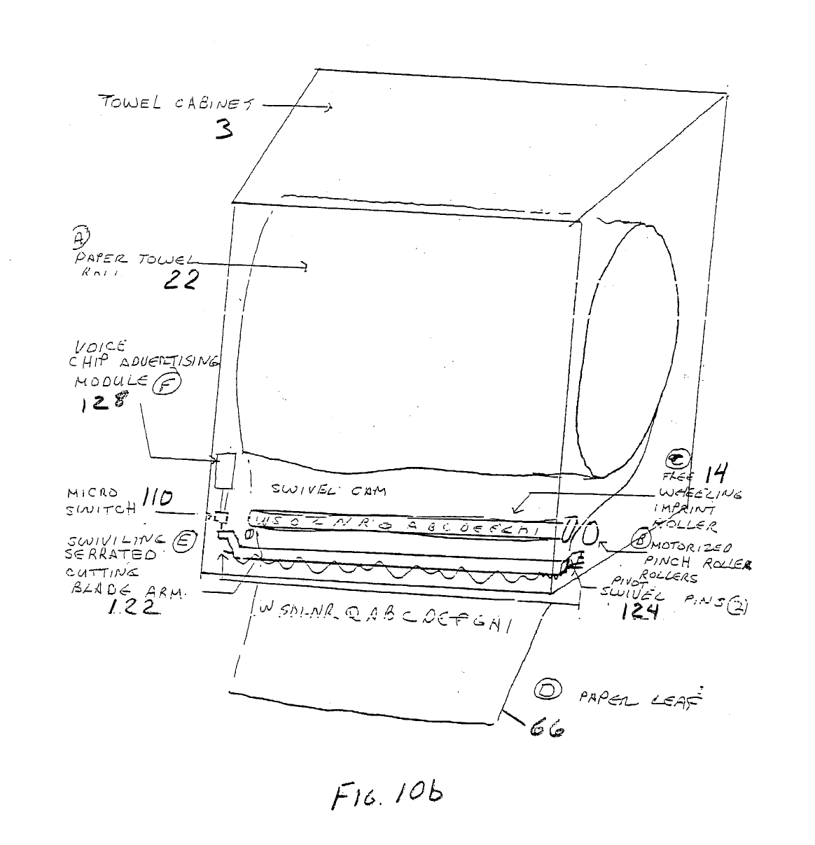

In an alternative emodiment, as shown in FIG. 9, the invention may be modified to assume the form of a flat sheet paper towel dispenser. A mechanical or infrared switch 90 senses when a user pulls a paper towel sheet 92 from the opening 94. This switch closes the annunciator circuit 29 via a wire connection 96 to an audio annunciator 28 in the form previously described. Referring to FIG. 10, another alternative embodiment could take the form of a newspaper vending machine. When a user opens the door 102 to retrieve a newspaper or other items, a first switch contact 104 is separated from a second switch contact 100, in a normally open switch relay configuration, such that a relay (not shown) such as a selenoid relay is closed connecting the battery power 82 to the microprocessor 84, as above described. This opens an electrical circuit via a wire connection 106 to an audio annunciator 28 in the form previously described. The switch employed may comprise an infrared/light sensor, a mechanical switch, or a magnetic switch as previously described.

With reference to FIGS. 10a and 10b, the message delivery device 10 can be incorporated in virtually all existing paper dispensers by employing and in some cases modifying certain components, such as a blade arm 122, lever 12 and, or infrared/light sensor 130, to activate the annunciator/voice chip 28. For instance, certain dispensers employ a light sensor 130 to dispense paper and a serrated bar 122 to cut the paper and reset the light sensor 130. In an alternative embodiment, the infrared/light sensor 130 is electrically connected to the annunciator/voice chip 28 so that the annuncitor/voice chip 20 is energized when the infrared/light sensor 130 is triggered. Some dispensers have a serrated arm 122 that pivots about pin 124 or hinge when paper 66 is removed. In another embodiment, the invention 10 mechanically couples or communicates the bar 122 to a switch 110, such as a limit switch, so the annunciator/voice chip 20 is energized when the bar 122 is actuated. Alternatively, the switch 110 has a light sensor or some other electrical means of detecting movement of the bar 122 such that the annuciator/voice chip 20 is energized when the switch 110 is triggered in response to actuation of the bar 122. Alternatively, a micro switch, limit switch or comparable substitute 110 lever 12 is positioned proximal the lever 12 so that the switch 110 is actuated when the lever 12 is pulled and, or released resulting in energizing the annunciator/voice chip 128 In another embodiment, a pin 114 protrudes from one of the rollers 62, 64 such that it actuates a lever or limit switch 110 resulting in energizing the annunciator/voice chip 20. In another embodiment, when a pinch roller rotates and an offset pin on the end of the roller contacts a switch arm to actuate the switch.

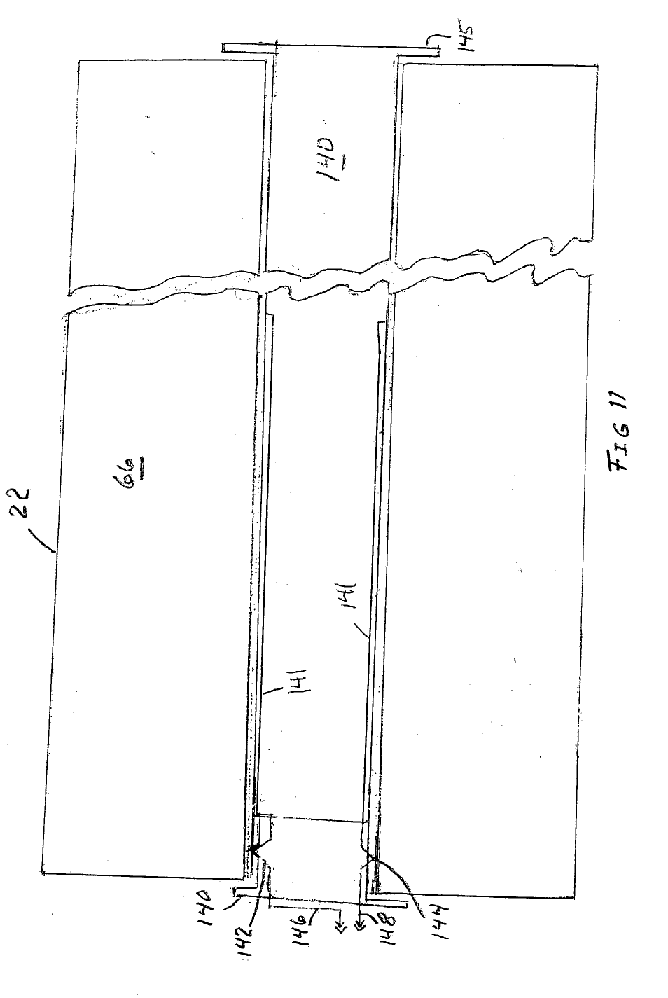

In an alternative embodiment, the instant invention 10 has a modified paper roller 140 that controls and dictates the source of paper that can be used in the dispenser 10 so that the annunciator/voice chip 20 will work. With reference to FIG. 11, the paper roller 140 comprises a tube lined with a metal foil or conductor 141 and wires 146 extend from the conductor material 141 and are electrically connected to the annunciator/voice chip power source so as to connect the power source to the annunciator/voice circuit. Without the conductor 141 power is not available to the annunciator/voice chip 20. The conductor 141 is preferably positioned inside the tube so as to not interfere with the paper. Alternatively, the conductor 141 may comprise a wire bridge. The tube 140 may be mounted to a spindle 145 for engaging the end cap 24.

In another embodiment, the instant inventor may include detachable coupons on the paper or paper dispenser that are accessed when paper is removed. The coupons may be attached through perforations to the paper at the top, bottom or side, or may comprise of individual sheets dispensed with the paper.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What is claimed is:

1. A paper dispenser message system, said system comprising:
means for dispensing paper;
means for delivering at least one message; and
switch means, in communication with said message delivery means, for facilitating the activating of said message delivery means when said switch is triggered.

2. A system as recited in claim 1, wherein said switch means comprises:
comprises means for sensing when paper is dispensed from said means for dispensing paper.

3. A paper dispenser message system as recited in claim 1, wherein said dispensing means further comprises means for placing at least one message on said paper as it is dispensed.

4. A paper dispenser message system as recited in claim 1, wherein said dispensing means comprises a housing for storing paper, said message delivery means and said switch means.

5. A system as recited in claim 1, wherein said switch means further comprises means for actuating when a door to said means for dispensing paper is opened.

6. A system as recited in claim 1, wherein said switch means comprises means for actuating when a lever of said means for dispensing paper is depressed.

7. A system as recited in claim 1, wherein said system further comprises:
a lever that causes paper to be dispensed when actuated;
a switch in communication with said lever and said message delivery means wherein said switch means is actuated when said lever is at least partially actuated.

8. A system as recited in claim 1, wherein said system further comprises:
a light sensor in communication with said switch means, said switch means being actuated when said light sensor is triggered.

9. A system as recited in claim 1, wherein said system further comprises:
a roller that guides paper out of said paper dispenser;
a pin on said roller; and
a trigger in communication with said switch means wherein said pin actuates said trigger when said roller is actuated.

10. A system as recited in claim 1, wherein said system further comprises:
a bar adapted for cutting paper and pivotly connected to said means for dispensing paper; said bar being in communication with said switch means wherein said bar causes said switch means to actuated when said bar is at least partially actuated.

11. A paper dispenser message system as recited in claim 1, wherein said message means comprises:
means for audible annunciation;
processing means to play back at least one message through said annunciation means; and
timing means to deliver power to said processor from a power source.

12. A message means as recited in claim 11, wherein said timing means provides said power to said play back means for a duration of time at least equal to the running time of the longest message.

13. A message means as recited in claim 11, wherein said system further comprises at least one coupon dispensed by said paper dispensing means.

14. A message means as recited in claim 11, wherein said play back means further comprises means for retrieving at least one message from a storage means when said processing means receives said power.

15. A retrieval means as recited in claim 14, further comprising means to selectively retrieve said messages in random and sequential order.

16. A paper dispenser message system, said system comprising:
means for dispensing paper;
means for audibly delivering at least one message; and
switch means, in communication with said message delivery means, for facilitating the activating of said message delivery means when said switch is triggered.

17. A system as recited in claim 16, wherein said system further comprises:
a lever that causes paper to be dispensed when actuated;
a switch in communication with said lever and said message delivery means wherein said switch means is actuated when said lever is at least partially actuated.

18. A system as recited in claim 16, wherein said system further comprises:
a light sensor in communication with said switch means, said switch means being actuated when said light sensor is triggered.

19. A system as recited in claim 6, wherein said system further comprises:
a roller that guides paper out of said paper dispenser;
a pin on said roller; and
a trigger in communication with said switch means wherein said pin actuates said trigger when said roller is actuated.

20. A system as recited in claim 16, wherein said system further comprises:
a bar adapted for cutting paper and pivotly connected to said means for dispensing paper; said bar being in communication with said switch means wherein said bar causes said switch means to actuated when said bar is at least partially actuated.
